(19) United States
(12) Patent Application Publication
(10) Pub. No.: US 2014/0026379 A1
(43) Pub. Date: Jan. 30, 2014

(54) SYSTEM AND METHOD FOR THE MOUNTING AND/OR REMOVAL AS WELL AS MAINTENANCE OF A NEEDLE BOARD, NEEDLE FOR A NEEDLE BOARD

(71) Applicants: Guido Herzog, Rheineck (CH); Bernhard Knapp, Freimersheim (DE); Roberto Rahn, Enkenbach-Alsenborn (DE); Marc Rochel, Mainz (DE)

(72) Inventors: Guido Herzog, Rheineck (CH); Bernhard Knapp, Freimersheim (DE); Roberto Rahn, Enkenbach-Alsenborn (DE); Marc Rochel, Mainz (DE)

(21) Appl. No.: 14/111,302

(22) PCT Filed: Apr. 12, 2012
(86) PCT No.: PCT/EP2012/001590

§ 371 Date: Oct. 11, 2013

(30) Foreign Application Priority Data
Apr. 12, 2011 (DE) 10 2011 016 755.2

(51) Int. Cl. D04H 18/02; B23P 19/04; B23P 6/00

(52) U.S. Cl. CPC D04H 18/02; B23P 6/002; B23P 19/04
USPC 28/115; 29/712; 29/402.08; 29/407.04; 29/407.05

(57) ABSTRACT

An arrangement and a method are provided for upgrading/downgrading and maintenance (fitting, removal, selection, or repair) of a needle board (1) of a needle machine for nonwoven or needle felt production. The arrangement has at least one tool (2) and has a holding device (3) for holding the needle board (1). The tool (2) may be positioned relative to a needle bore (4) and/or a needle (5) of the needle board (1) by means of a control and drive device and at least one detection device. The arrangement increases the flexibility of the positioning of the tool and allows operations such as selection, repair of the needles by virtue of the tool (2) and the control and drive device being assigned at least one robot (7, 8). The robot (7, 8) is provided with at least one articulatedly mounted tool arm (9, 10) on which the tool (2) is arranged.

### CROSS REFERENCE TO RELATED APPLICATIONS

This application is a United States National Phase Application of International Application PCT/EP2012/001590 filed Apr. 12, 2012 and claims the benefit of priority under 35 U.S.C. §119 of German Patent Application DE 10 2011 016 755.2 filed Apr. 12, 2011, the entire contents of which are incorporated herein by reference.

### FIELD OF THE INVENTION

The present invention pertains to a system for the mounting and/or removal as well as the maintenance of a needle board of a needle machine for nonwoven or needle felt production, especially for automatically carrying out various operations, such as fitting or removal, possibly selection, repair, with at least one tool and with a holding device for holding the needle board, wherein the tool can be positioned in relation to a needle bore and/or a needle of the needle board by means of a control and drive device and at least one positioning device. In addition, the present invention pertains to a method for mounting and/or removal as well as maintaining a needle board of a needle machine for nonwoven or needle felt production, especially for automatically carrying out various operations, such as fitting or removal, possibly selection, repair, wherein needles or needle bores are detected on the needle board and wherein a tool is positioned in relation to the needle board corresponding to the detected data. Finally, the present invention also pertains to a needle for a needle board of a needle machine for nonwoven or needle felt production, especially for a system or a method as described above, with a tip and with an end located opposite the tip.

### BACKGROUND OF THE INVENTION

Needle boards are part of needle machines for nonwoven or needle felt production and are fitted with special needles. The needles machines are used to strengthen/compact fiber materials, fibers and filaments. Products such as spunbond, imitation leather, imitation suede, needle felt, which may contain nonwoven, are produced. The needles are L-shaped due to their respective fastening hooks and are passed through bores in the needle board and fixed. The needles are subject to very high stress and are damaged over time.

Various devices for changing the needles are known from practice. The fact is that the manual variant of needle change may lead to painful injuries and systems that avoid human intervention and make the needle change operations automatic and purely mechanical have therefore been developed.

DE 39 41 159 C2 shows a device for the automatic fitting and removal of needle boards, wherein the operations of pushing in and out are performed by tools acting on the front side and the rear side of the needle board, which are arranged opposite each other. These bilaterally operating tools are mounted movably in the machine frame and are actuated and driven by a control and drive device. The machine frame is equipped with rails, on which the tools are displaced in order to assume their positions in relation to the needle or needle bore. The tools are arranged opposite each other during each operation and must be aligned. Optical detection systems, which are quasi comprised by the drive and control device and communicate with same, are used to align the tools relative to the needle board. The aligned positioning and the consecutive motion corresponding to a grid require a mechanically very precise construction, which is inflexible and is less suitable in practice.

A device that is used to perform maintenance operations, such as fitting and removal at the needle board is also known from U.S. Pat. No. 6,393,693 B1. The basic design in which two opposite tools acting on this side and the other side of the needle board is selected here as well. The tools are guided on rails and must be aligned. The costs of the heavy, but nevertheless precise machine construction are very high here as well. In addition to this, there are labor costs for a person who fills the magazine with needles.

It is common to both of the above-mentioned devices that the desired positions are approached in practice consecutively. On the way from the first to the next needle bore on the needle board, the needle board must be crossed over completely, and the paths defined by the rails are to be observed. The motion process can take place at right angles only in height and width. If a certain needle is to be reached, this is possible only by moving along the preset paths and passing over all other areas. It is obvious that the time required is relatively long if the motion of the tool is possibly over two degrees of freedom only, bound to rails extending at right angles to one another.

As is described in EP 1 953 287 A1, it is also possible to work consecutively on the front side and the rear side of the needle board during fitting. The needles are first inserted, the position of the needle board is then changed, and the needles are fixed/pressed in. The automatic fitting device known from EP 1 953 287 A1 operates with a multiple collet chuck and fits the needle board with needle groups, which are prepositioned over the width of the needle board. The prior-art automatic fitting device requires great manual and design effort due to the groupwise arrangement of the needles to be fitted, already because of the needle feed with a screw conveying means for providing the needles for the multiple collet chuck alone. Working is possible in the preset grid only. Approaching a desired position is not possible with the automatic fitting device in question. This is also not a fully automatic method, because the needles must be inserted into the needle feed in a labor-intensive manner.

### SUMMARY OF THE INVENTION

Based on the state of the art, a basic object of the present invention is to provide a system and a method of the type in question, which increase the flexibility with which the tool is positioned and which are associated with little manual effort. In addition, the option shall be opened up for operations such as selection, as well as repair of the felting needles. Finally, it shall be made possible to deviate from the conventional design of the needle for a needle board in an advantageous manner.

The above object is accomplished in respect to the system by the features according to the invention. A system of the type in question is designed accordingly such that the tool and the control and drive device are assigned to at least one robot, and that the robot is provided with at least one tool arm mounted in an articulated manner, on which the tool, which makes it possible to carry out the desired operation, is arranged.

The above-mentioned object is accomplished in respect to the method by the method features according to the invention. A method of the type in question is improved accordingly such that the operations are carried out by means of a tool arm of a robot, which tool arm is mounted in an articulated manner and at which the tool suitable for the respective desired operation is arranged.

The above object is accomplished in respect to the needle by the features of the invention relating to a needle for a needle board of a needle machine for nonwoven or needle felt production, with a tip and with an end located opposite the tip. A needle in question is accordingly designed such that the end of the needle located opposite the tip is designed in the manner of a flat, especially round or elliptical head, which is slightly larger than the cross section of the needle.

It was first recognized that devices and methods known from the state of the art require high precision and must be machined with very high precision according to the precision mechanical methods in order for the tools working on both sides at the needle board to be flush, taking into account the needle bore in the needle board or with the needle itself. The systems are very expensive due to the required precision. In addition, it was recognized that the motion of the tool in height and width is bound to rails and guides, and the speed of the operation cannot therefore be optimal even due to the path that is to be traveled while approaching the operation site.

It was recognized according to the present invention that the flexibility with which positioning can be performed is increased if the construction is made slender and if direct positioning at the needle board is made possible, in principle, free from a preset mechanical guide. It was recognized according to the present invention that this can be achieved if at least one robot with at least one tool arm mounted in an articulated manner is used, wherein the robot comprises the control and drive device, and at least one detection means is provided. The tool arm is always fitted with the correct tool. The tool is mainly a gripper, suction unit or magnet, which either picks up the needle and inserts same into the needle bore of the needle board, or it is a tool that presses or extracts the needle out of the needle bore. Since the robot is equipped with articulated tool arm and tool, it can remove needles even from a removal site, and the manual effort is therefore extremely low. All operations at the needle board take place automatically. Furthermore, it is of considerable significance that the robot has a great freedom of motion and it makes it possible, for example, to pick up the needle freely or to assume a position obliquely to the needle board rather than frontally only as before.

It is stated concerning the method according to the present invention that the same advantages apply to the method as to the system. It is pointed out that it makes possible the mobility of the articulated tool arm at the robot with the corresponding tool to work point by point relative to a selected needle or needle bore.

A new, advantageous design of the needle at the opposite end of the tip was found within the framework of the present invention. This inventive variant is in a direct technological connection with the system according to the present invention and with the method according to the present invention. Due to its flexibility and motor function, the robot makes it possible to work in very small spaces. It is therefore possible to deviate from the conventional hook at the end located opposite the tip of the needle and to find completely different solutions. The end of the needle located opposite the tip shall be designed according to the present invention in the manner of a flat, especially round or elliptical head, which is slightly larger than the cross section of the needle of needle shaft. As a result, the needle density on the needle board can be increased and the quality of the nonwoven or felt to be produced can be changed.

It would also be possible to embody more subtle mechanisms for securing against twisting due to the high precision of the robot. In particular, the needle shaft could have an elliptical or triangular to polygonal cross section. The cooperation with the needle bore could be based purely on non-positive connection. It would also be possible to achieve a positive-locking connection.

In respect to an embodiment of the robot, the robot could be equipped with two articulated arms. The second articulated arm could extend over the needle board and apply a tensile force on the needles on the rear side of the needle board, for example, during the removal of the needles, while the first articulated arm applies compressive force to the tips of the needles on the front side. A variant in which two or more robots operate on one side at the now rotatably mounted needle board would be conceivable as well. It is also possible to arrange a robot each on the front side and the rear side of the needle board.

If the tool arm is not particularly long, the robot could be able to be brought into the area of the needle board at which the operation shall be carried out. Conversely, even though it would also be possible to move the needle board to the robot, this is not necessary owing to the flexibility of a robot. The robot could be moved to the needle board in the conventional manner by means of structural guide elements, such as rails. The rails would now be needed in one direction of motion only concerning the width of the needle board. It is preferred in view of a high flexibility and free mobility if the robot can be brought into the area of interest of the needle board on rollers or in a floating manner by means of a magnetic field. The vertical adjustability is made possible according to the present invention in a flexible manner by means of the tool arm mounted in an articulated manner.

In view of the many and diverse functions of the robot, which not only must be positioned but also performs a great variety of processing steps at the needle board and, moreover, detects data and transmits same, it is advantageous if the control and drive device comprises at least one separate computer. This computer could offer the computing capacity that is needed to position the robot and to calculate the next target position of the robot, to coordinate processes and to process detected data. This computer makes available, in particular, a memory in the gigabyte to terabyte range, which cannot be achieved by a conventional control.

It is advantageous, especially in applications in which a robot each works on the front side and on the rear side of the needle board or a robot works on the front side and a portal works on the rear side, if at least one MPC unit (memory-programmable control unit), which coordinates the entire system or unit with one another and embodies the interface between computer and hardware, is also provided in addition to the computer.

To allow for the different necessary motions corresponding to the requirements imposed on the tool, the tool arm could be movable about a plurality of, especially six axes. Six axes are preset by the design of an articulated-arm robot, which is known per se, and are distributed over the entire robot. Due to the plurality of degrees of freedom, it is possible not only to perform positioning in relation to the needle board, but it is also possible, for example, to remove a needle to be mounted from a removal site or even to deposit an extracted needle from a removal site or even to deposit an extracted needle on a deposit site. The removal site for new needles to be fitted and the deposit site for removed needles are provided for this in the range of motion of the articulated tool arm. For example, they can be arranged on a base plate of the robot. In respect to the deposit site, it may, of course, also be considered that the damaged needles simply fall into a collecting chute at the needle board and are removed therefrom into a collection container. As an alternative, it would also be possible to provide at least two deposit sites, in which case one deposit site is used to receive undamaged, reusable needles and the other one receives the damaged needles.

It must be stated that the independent removal of the new needle must be carried out by the robot in order to avoid manual work and thus eliminate the risk of injury and to increase reliability. The design effort for a conventional needle guide is avoided by the articulated tool arm at the robot. Another measure to avoid manual effort is the automatic feeding of needles to the removal site. This could be carried out, for example, by means of conveyor belts, or the conveyor belts could be removal sites themselves and would be able to be reached by the robot from each of the robot positions in relation to the needle board.

The detection device could operate optically and comprises a camera for detecting the needle board for this. The camera could be arranged, for example, directly at the tool or tool arm of the robot and communicate with the control and drive device, especially the separate computer with the large memory capacity. In addition to the camera, a lighting means associated with the camera could be provided to improve the image quality. As an alternative to a camera, it would also be possible to use a laser scanner or an inductive scanner or even a capacitive scanner.

The system according to the present invention can freely detect the needles and/or needle bores at the needle board by means of its detection device and transmit the detected data to the control and drive device, preferably to the separate computer, which contains a corresponding image processing program and more software, which is necessary for the correct operation and positioning. The actual positions of the needles or needle bores of the needle board can then be determined there. The camera can detect either the entire needle board, which makes sense in case of complete fitting with new needles or in case of removal of all needles, but it is also possible, as an alternative, especially if the operation shall be selective, for the detection operation to be reduced by partial areas of the needle board.

Insofar as operations such as selection and repair are taken into consideration, it would be possible for an even more accurate detection of the needle to provide a proximity switch or further additional detectors, which detect, for example, the tip of the needle more accurately and transmit data to the control and drive device. For example, a capacitive or inductive proximity switch would be considered. It can be determined precisely at the tip of the needle whether the tip is blunt or whether it deviates from the axis of the needle bore and is thus no longer aligned in an undesired manner.

Besides the needle tip, the needle of a needle board conventionally also has a hook at the opposite end, which is usually located on the rear side of the needle board within a groove provided there in the mounted state of the needle. The hook formation has a securing function against twisting. In addition, the hook facilitates the manual removal of the needle. An essential and significant variant of the present invention pertains to the novel embodiment of the needle, where a head, a thickened part, a flat area, a cam protruding downwards slightly or other graspable, preferably cost-effective constructions, are possible instead of a hook. A graspable surface structure instead of a hook would also be conceivable at the free end of the needle in question.

If only one robot with only one tool arm is provided and one would not like to move the robot from the front side to the rear side of the needle board, rotatable mounting of the needle board at the holding device could also be possible as an alternative.

According to another exemplary embodiment of the system according to the present invention, a portal, via which operations can likewise be carried out at the needle board, could be provided in addition to the robot. The portal could likewise have a tool and is of interest because a portal can apply stronger forces. This is advantageous, for example, when fixing the hook of a conventional needle within a groove on the rear side of the needle board or even when extracting the needle from the needle bore. The robot could operate now on the front side of the needle board and the portal on the rear side of the needle board. The portal would, of course, also have a control and drive device, a tool, and a detection means. The detection means could likewise have proximity switches or further additional detectors in addition to a camera.

The tool of the portal could operate in at least three directions of motion. In addition to the three directions of motion that are known anyway and are necessary, namely, width, height and depth, a rotary motion about a fourth axis could be achieved as well. When looking at it in this light, the motions of the tool itself, for example, the collet motion of a gripper, are left out of consideration.

Coordinated operation could take place during the removal of needles in the exemplary embodiment, in which the robot operates on the front side of the needle board and the portal operates on the rear side. The operations of the robot and of the portal would take place staggered in time, with the needle being inserted on the front side of the needle board via the robot and with the fixing taking place by inserting the bent hook of the needle into a groove on the rear side via the portal. The motion of the robot and portal could take place over the width of the needle board on conventional rails in the exemplary embodiment in question.

As an alternative to the needle board-portal arrangement, the overall size of the robot could, of course, also be adapted along with the number of tool arms. Furthermore, it would also be possible to work with two or more robots or even with one robot and one portal on the same side of the needle board. The system according to the present invention allows great leeway here. It is essential for the present invention that the mobility of the tool makes possible short and direct paths to the operation site.

In case repair shall be performed on selected needles, a straightening tool for a bent needle and/or a sharpening tool for a blunt needle could be associated with the tool arm. These could preferably be arranged on a rotatable tool table, on which additional gripping tools and at least one detection device are arranged.

Distinction is made concerning the method between three basic embodiments/operations, namely,
fitting of the empty needle board with needles and fixing of said needles,
removal/extraction of the needles from the needle board, and
selection/checking, possibly repair of needles.

The robot is to be positioned in relation to the needle board prior to all operations. Depending on the type of operation, either the front side of the needle board (in case of selection, straightening, repair) or the rear side of the needle board (in case of fitting, removal) could be detected, i.e., scanned in a contactless manner, for this depending on the type of the operation, and the positions of the needles or needle bores could be determined from this. As was already described in connection with the device, image data could be detected and transmitted by means of the camera, but laser scanners could also perform detection in a location-discrete manner and transmit the data thus detected. The detected data on the needles (selection) on the front side or relative to the needle bores (fitting) or hooks (removal) on the rear side of the needle board are transmitted by the detection device to the control and drive device of the robot, optionally also of a portal. The detected data are sent especially preferably to a separate computer, which is comprised by the control and drive device and has an especially high computing capacity in order to be able to detect and transform the detected data and to determine the real positions of the needles and needle bores. The positioning of the robot relative to the needle board can then take place on this basis.

During the fitting operation, the mechanical removal of the needle by the tool arm or the tool of the robot from a removal site could also be part of the automated fitting operation. One could resort to a preceding detection operation here as well, regardless of whether detection is carried out with a camera or a laser scanner or other detection devices.

At any rate, the detection device could be, for example, the same detection device that also detects the needle board. For example, an image of a needle could be recorded with the detection device in case of a camera, and the detected data here image data could then be transmitted to the control and drive device, especially the separate computer. The data are electronically detected and processed there such that the position and the quality of the needle are determined and the quality is optionally also checked by an additional comparison operation against reference data. What is ultimately important already here is to avoid the removal of a damaged needle, so that the condition of the needle, especially of the tip is significant already before removal. If a damaged needle is recognized at the removal site, it is disposed of.

After the electronic data processing has taken place, the tool is actuated to remove the needle. The motion of the tool arm and of the gripper is initialized. When the needle is picked up by the tool/gripper, the tool reaches a position from which the motion of the needle board will then take place. The position may be located at a spaced location from the removal site, but the motion may also be carried out directly from the removal position/needle mounting position of the tool to the needle board. In case the needle was defective at the removal site, a new needle is detected and mounted.

Before the removed needle is now actually inserted into a needle bore, detection of the needle bore is performed. Defects, which could be caused, for example, by contamination of the needle bore or damage to the needle board, shall thus be avoided already at the initial stage. It is significant in this connection that the tool is arranged on a rotatable tool table together with additional tools. If a needle bore is contaminated, a cleaning tool could be positioned by rotating the table. All this and, of course, also a fine adjustment of the position of the tool carrying the removed needles take place after transmission of the detected data relating to the needle bore to the drive and control device/to the separate computer. The fitting operation could then be repeated as often as necessary as long as the needle board is fitted with the desired quantity and quality.

If conventional needles with tip and hook are used, inserting the needles into the needle bores is not usually enough to allow the needle board to become suitable for use. A fixing operation must rather be performed, in which the hooks are pressed, pushed or turned into grooves provided especially for this purpose on the rear side of the needle board. This could be performed by the robot itself or by a second robot. Especially preferred is an embodiment in which a portal, which can apply stronger forces due to its stable form of construction, is used for fixing. This portal could also be arranged opposite the robot, so that rotation of the fitted needle board by 180° must take place prior to the use of the portal, and the fitted rear site will now face the portal.

According to a preferred exemplary embodiment of the invention related to the method, the fitting operation could contain the following visible steps:
a) Detection of the free needle bores on the rear side of the needle board,
b) Positioning of the robot relative to the needle board,
c) Detection of a needle to be detected in the removal site,
d) Picking up of the detected needle by the robot,
e) Detection of a needle bore,
f) Fine adjustment of the position of the robot or of the tool arm or of the tool
g) Insertion of the needle into a needle bore of the needle board
h) Repetition of steps c) through g) as often as necessary.

When the needle board has been fitted with needles, which make fixing necessary, the fitting is followed by the following steps using an arrangement with robot on one side of the needle board and a portal on the other side of the needle board:
I) Rotation of the fitted needle board by 180°,
j) Detection of the rear side of the needle board,
k) Positioning of a portal relative to the needle board,
l) Detection of the end of a needle, which end is located opposite the tip and is seated in the needle bore,
m) Fine adjustment of the position of the portal or of the tool located there,
n) Fixing of the end of the needle in question by the tool of the portal,
o) Repetition of steps j) through n) as often as necessary.

The method according to the above exemplary embodiment could be shortened in respect to steps e) and f) as well as the steps l) and m if an extremely precise first detection takes place in steps a) and j).

A corresponding software each, which processes the data obtained by the detection such that the necessary motion processes of the robot, of the portal and of the respective tool are carried out, is provided each in the control and drive device of the robot, on the one hand, and in the control and drive device of the portal, on the other hand. A common drive and control unit with one or two or more separate computers is conceivable as well.

The needle bores could be contaminated or damaged or the ends could not be seated concentrically in the needle bore. These are reasons why the needle end is detected at first on the rear side of the needle board before removal of the needle from the needle board, and also during fitting. These detected data are then sent to the control and drive device and the high-performance, separate computer, respectively, and processed electronically such that the position and the quality of the end of the needle are determined and the tool is then actuated, so that it will apply tensile force to the detected end of the needle and extract the needle from the needle bore. In addition to the tool, which extracts the needle from the needle bore, it would also be possible to provide a tool that is especially suitable for removing the hooks from the grooves at the tool arm or at a tool table.

According to a preferred exemplary embodiment of the present invention, compressive force is applied by the tool of the robot to the tip of the needle on the front side of the needle board in addition to the application of tensile force by the portal on the rear side of the needle board. The detection could first be performed for positioning the robot and the portal in this exemplary embodiment as well, but a detected per needle tip or end would then be performed once again in order to perform a fine adjustment/fine positioning of the respective tool. The control and drive devices/detection devices of the robot and portal preferably communicate with one another and act on the same needle via a simultaneous or coordination software. It is advantageous if the portal and the robot are actuated or driven by the same drive and control unit.

As soon as the needle is removed from the needle board, it could be fed to a deposit site, where all needles are collected. A simple solution is to simply open the tool and the needle falls into a removing chute beneath the needle board. The tool can then be available, at any rate, for the next needle to be removed. The removal operation repeated as often as necessary. As an alternative, it would also be possible to provide two different deposit sites, in which undamaged and damaged removed needles are deposited separately from each other.

Another advantageous operation, which is essential for the present invention, and which can be carried out by means of the system according to the present invention and due to the flexibility of mobility of the robot, is the selection of a needle or of a needle bore in connection with replacement and repair operation. This variant of the method according to the present invention makes savings possible, because only damaged needless must be removed and replaced instead of having to change all needles.

The positions of damaged sites could be determined at first after a first detection of the front side of the entire needle board with the partly damaged needle tips protruding downwards. The detected data of the entire needle board are compared for this against reference data stored in the drive and control unit, especially in the separate computer. Foreseeable position data could thus be calculated for the robot already in advance. The robot can then approach the relevant areas directly, and the time of a lengthy detection column by column or line by line can thus be saved. The comparison could be performed, for example, by means of an image processing software by the comparison of a reference image containing homogeneous needle tip surface with the current image data recorded by a camera.

An inductively operating proximity switch could be preferably used for the detection. A surface camera, which is directed towards the front side of the needle board and consequently towards the needle tips, could be problematic concerning distortions occurring in the image.

Regardless of whether each needle of the needle board is detected in the first step or the areas that are to be approached and deviate from the reference data are determined in a first step by an overall detection of the entire needle board and each needle in the area to be approached is then detected in a second step, the detected data concerning the individual needle are sent at any rate to the control and drive unit/to the separate computer. A comparison is made there with corresponding reference data concerning an undamaged needle and the position of the damaged needle that is possibly to be selected is determined, so that the robot/tool arm of the robot can then be accurately positioned there.

The statements made concerning the needle selection can also be extrapolated to needle bores, for example, if a needle tip is broken off and the needle bore is to be freed of the broken needle or if a needle bore was damaged during the breaking off of the needle or has simply become free for a new fitting.

The reference data could be generated in the good condition in a needle board-specific and/or needle-specific as well as needle bore-specific manner.

If a camera is used, image data are generated that pertain to the geometry of the needle. Based on the flexibility of the robot with its movable tool arm, it is possible to detect a plurality of image data, even from different angles of view, so that deviations can be reliably detected during the comparison with the reference data. The deviations may be in a range of 2/100 mm to 0.5 mm depending on the precision of the robot. It is important in this connection that the deviations must not be greater than ⅓ of the diameter of the needle bore, and deviations possibly tending towards zero are, of course, sought to be obtained.

After a needle or a group of needles that deviate from the reference data have been determined, the position data of these needles can be used to move the robot or even only the tool arm thereof into the area of these selected needles.

More information could then be obtained there via a proximity switch on the needle deviating from the reference data, and this information is then sent to the control and drive device of the robot. In addition, additional detectors, which can determine, for example, density properties, surface finish (wear) and further data, could be provided. All these data contribute to the selection of the correct operation for the particular needle.

It could consequently be determined in the control and drive unit of the robot, especially in the separate computer thereof, by means of a corresponding software whether the selected needle is to be removed or repaired.

Since the detection of the needles takes place under the aspect of the operation of selection and further mechanical operations on the front side of the needle board in relation to the needle tips, removal of a damaged, for example, broken-off needle that cannot be saved can take place only when a tool also reaches the rear side of the needle board in order to exert a tensile force on the end of the needle. Reference is made in this connection to the statements made in connection with needle removal.

If it is determined that the tip of the needle is no longer aligned with the needle bore, a straightening tool could be assigned to the tool arm for straightening the selected needle. The straightening tool could operate mechanically or thermally or magnetically. The straightening could then be performed corresponding to the reference data preset by the control and drive device.

If it is determined on the basis of image data or data on the surface finish that the needle was selected because of a blunt tip, a repair tool could be assigned to the tool arm for processing the needle. The repair of the needle could then be performed corresponding to the standard preset in the control and drive device. Removal of felt residues could also be performed or a protective or sliding layer could also be applied to the surface of the needle instead of a repair of the needle under a mechanical effect exerted on the surface.

There are various possibilities of embodying and perfecting the teaching of the present invention in an advantageous manner. Reference is made in this connection, on the one hand, to the claims following patent claim 1, and, on the other hand, to the following explanation of two exemplary embodiments of the present invention on the basis of the drawings. Generally preferred embodiments and variants of the teaching will also be explained in connection with the explanation of the mentioned exemplary embodiments of the present invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the system according to the present invention according to a first exemplary embodiment;

FIG. 2 is an enlarged perspective view of the robot from the system according to FIG. 1, after picking up a needle from a removal site;

FIG. 3 is an enlarged perspective view of the system from FIG. 1 shortly before the insertion of the needle into the needle board;

FIG. 4 is a perspective view of the system according to the present invention according to a second exemplary embodiment;

FIG. 5 is a representation of a detail view of the scanned front side of the needle board from FIG. 1 or 3 concerning the empty needle bores;

FIG. 6 is a view of the needle as it is used in both exemplary embodiments;

FIG. 7 is a view of the needle from FIG. 6 as an interim result of a needle detection algorithm;

FIG. 8 is a representation of a detail view of the scanned rear side of a needle board from FIG. 1 or 3 from another process step, wherein the fitting and fixing have already been performed; and

FIG. 9 is a representation of a detail view of the scanned front side of a needle board from FIG. 1 or 3 from another process step, where a selection of damaged needles will be performed next.

### DESCRIPTION OF THE PREFERRED EMBODIMENTS

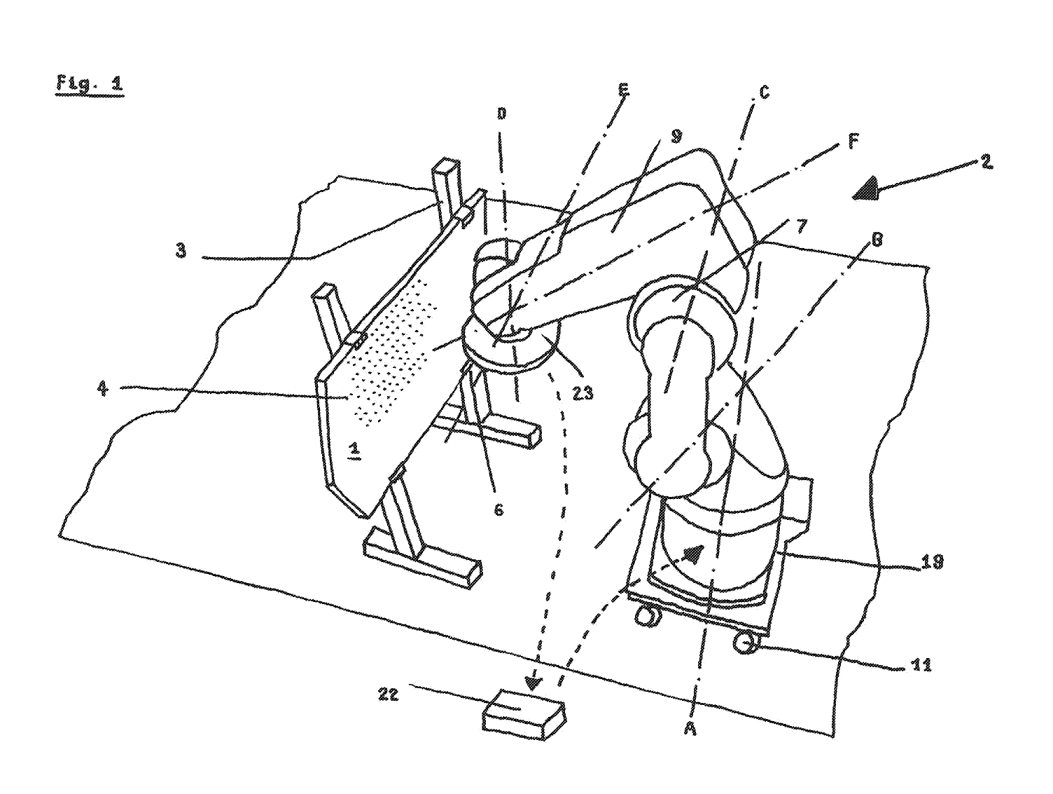

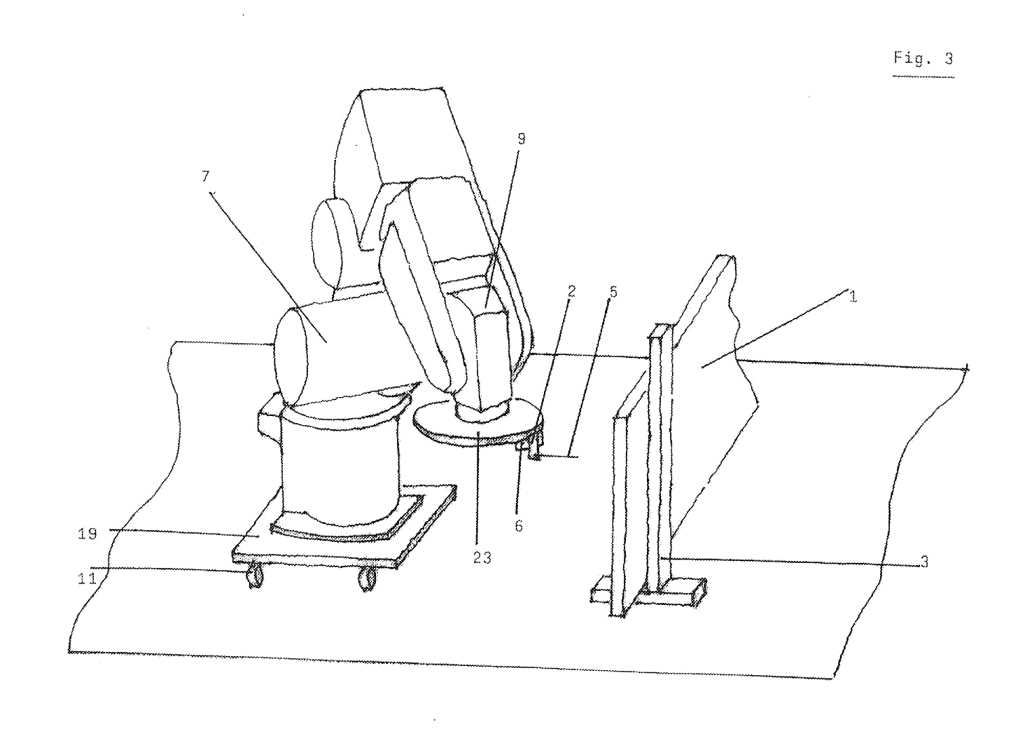

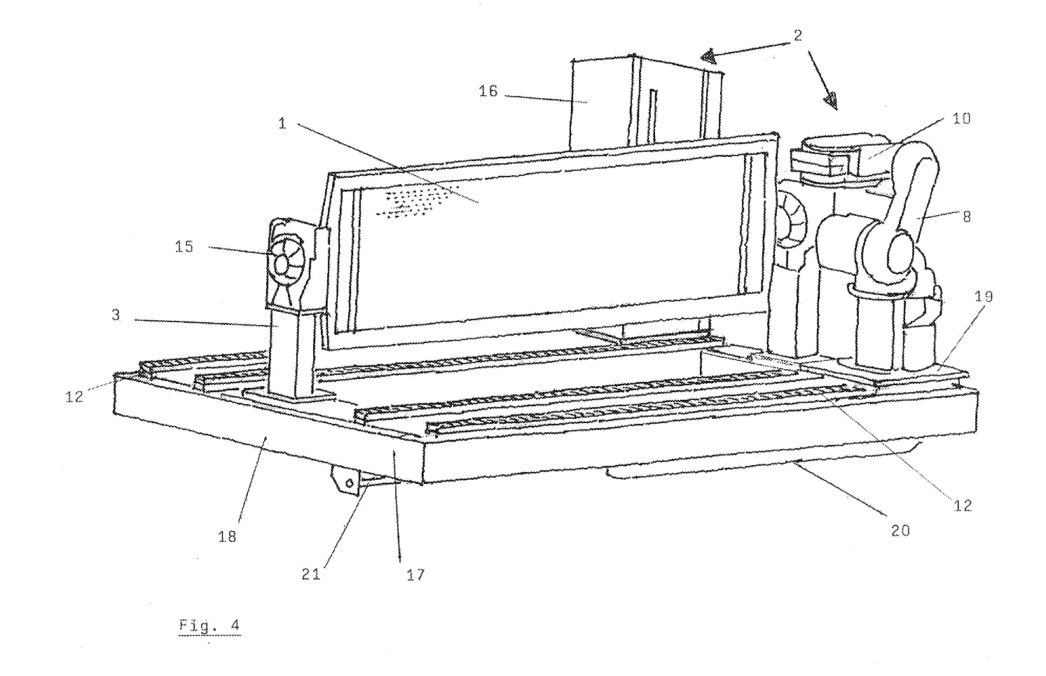

Referring to the drawings in particular, FIGS. 1, 3 and 4 show a system for the mounting and/or removal as well as maintenance of a needle board 1, which is expanded from a needle machine for nonwoven or needle felt production. The system is used to carry out different operations automatically at the needle board 1, such as fitting or removal, possibly selection, repair. A tool 1 and a holding device 3 for holding the needle board 1 are provided in the first exemplary embodiment shown in FIGS. 1 and 3. Two tools 2 and a holding device 3 for holding the needle board 1 are provided in the second exemplary embodiment shown in FIG. 4.

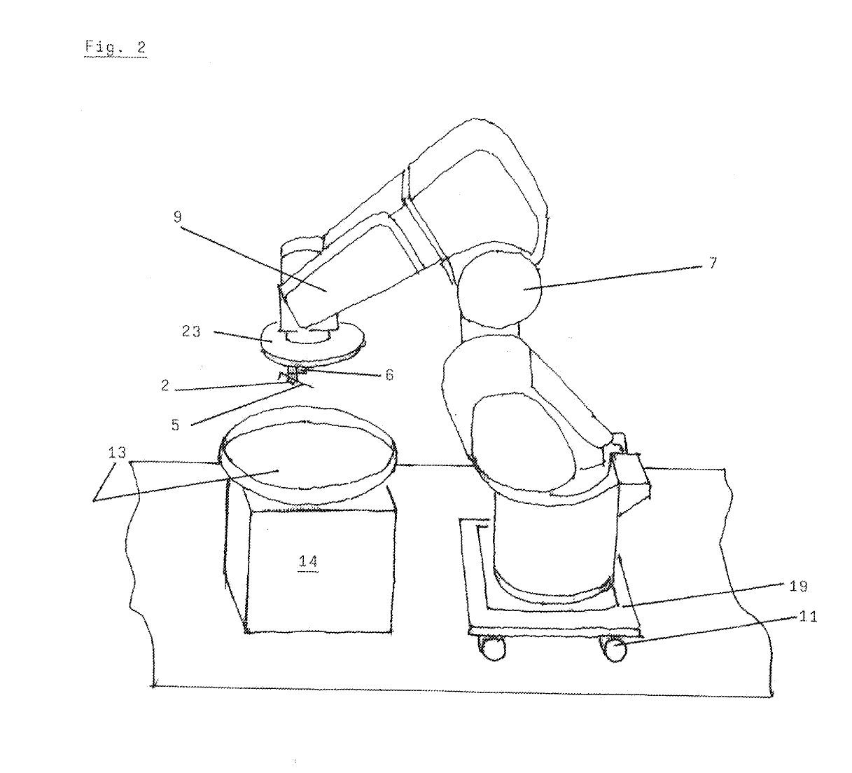

The tool 2 can be positioned in relation to a needle bore 4 shown in FIGS. 1 and 5 and/or in relation to a needle 5 shown in FIGS. 2, 6 and 7. The positioning is performed via a control and drive device as well as a detection device, which are comprised by the tool 2. A camera 6, which acts as a detection device and is assigned to the tool 2, is shown in FIGS. 2, 3.

The tool 2 and the control and drive device are assigned according to the present invention to a robot 7, 8 and the robot 7, 8 is provided with a tool arm 9, 10, which is mounted in an articulated manner and on which the tool 2, which permits the desired operation to be carried out, is arranged. The tool 2 and camera 6 are arranged on a rotatable tool table 23, which is shown in FIGS. 1 through 3. The tool table 23 may also be or become fitted with additional tools or sensors or detection devices. Additional tools, not shown here, which will be used depending on the desired operation on the needle board 1, are mounted on the tool table 23 in the exemplary embodiment being shown here.

A part of the control and drive device, which is not shown otherwise in detail, is shown in FIG. 1 and pertains to a separate computer 22. This computer 22 ensures the computing power that is needed to position the robot 7, 8, to coordinate process steps, and to process detected data, which come from the camera 6. Computer 22 makes a storage capacity in the gigabyte range to the terabyte range available for this. Besides computer 22, the control and drive device comprises an MPC unit, not shown here, which communicates with the computer 22 and is ultimately responsible for the motion processes of the robot 7, 8. It is indicated by the arrows drawn in broken lines that data detected by the tool table 23 or by the camera 6 arranged there, not shown in FIG. 2, are sent to the computer. Finally, after data processing and determination of the position, the robot 7 is then controlled. Not shown are the details concerning an MPC unit, which is in connection with the computer 22 and which, just as computer 22, is a part itself of the entire control and drive device.

Robot 7, 8 can be moved into an area of the needle board 1 at which the operation shall be carried out. According to the first exemplary embodiment, the robot 7 has rollers 11 for this. Robot 8 can be displaced on rails 12 according to the second exemplary embodiment. The tool arm 9 can be moved about six axes A, B, C, D, E, F. This also applies to the tool arm 10.

The system according to the first exemplary embodiment comprises a removal site 13, which is arranged in the range of motion of the tool arm 9 and contains no needles 5 to be fitted. Only one needle is shown here on behalf of further needles 5. This is already picked up by the tool 2 (gripper) and pivoted upwards via the tool arm 9. The removal site 13 is arranged on a base 14 here. The camera 6 is used here to detect the new needle 5 of the removal site 13 that is to be fitted.

The same camera 6 is also used to detect the needle board 1, namely, the needles 5 and/or the needle bores 4 located there. FIGS. 1 through 3 show phases of the fitting operation. The needle bores 4 are therefore detected there on the rear side of the needle board 1. The image data obtained during the detection by means of camera 6 are sent to the computer 22 of the control and drive unit of robot 7 and, after data processing, positioning of the robot 7 relative to the needle board 1 is performed. The rollers 11 are activated for this by the control and drive device comprised by the robot 7, especially by the MPC unit thereof. The robot has already reached a position in FIG. 3 and fitting of the needle board 1 with the needle 5 is imminent.

It is shown in FIG. 4, which pertains to the second exemplary embodiment, that the needle board 1 is mounted rotatably via pivot bearing 15 at the holding device 3. Besides, a portal 16, via which operations can likewise be carried out on the needle board 1, is provided there in addition to the robot 8. Portal 16 comprises a tool not shown in detail here, which operates in four directions of motion. The robot 8 is arranged on the front side of the needle board 1 and the portal 16 is arranged on the rear side of the needle board 1 during the needle removal operation. Work is performed consecutively, always after rotation of the needle board 1, during other operations.

The system according to the second exemplary embodiment comprises a rectangular frame 17, on which the holding device 3 with the needle board 1 is arranged centrally, from transverse side 18 to transverse side 18 of the frame 17. Likewise from transverse side 18 to transverse side 18, rails 12 are arranged at the frame 17 on both sides in parallel to the holding device 3 and to the needle board, on the one hand, for positioning the portal 12 and, on the other hand, for positioning the robot 8. A trailing device 20 for electric lines and a linear guide 21 herefor extend under the rails 12. FIG. 4 shows frame 17 as such together with the system. In the complete state, the frame would be arranged in a housing with substructure, which was omitted here.

The robots 7, 8 are fixed via a base plate 19. Base plate 19 with the robot 7, 8 is brought to the operation site at the needle board 1 either via rollers 11 arranged thereon or via rails 12. Slide bearings, not designated specifically there, which are displaced on the rail 12 and are connected to the underside of the base plate 19, are mounted there in case of the rails 12.

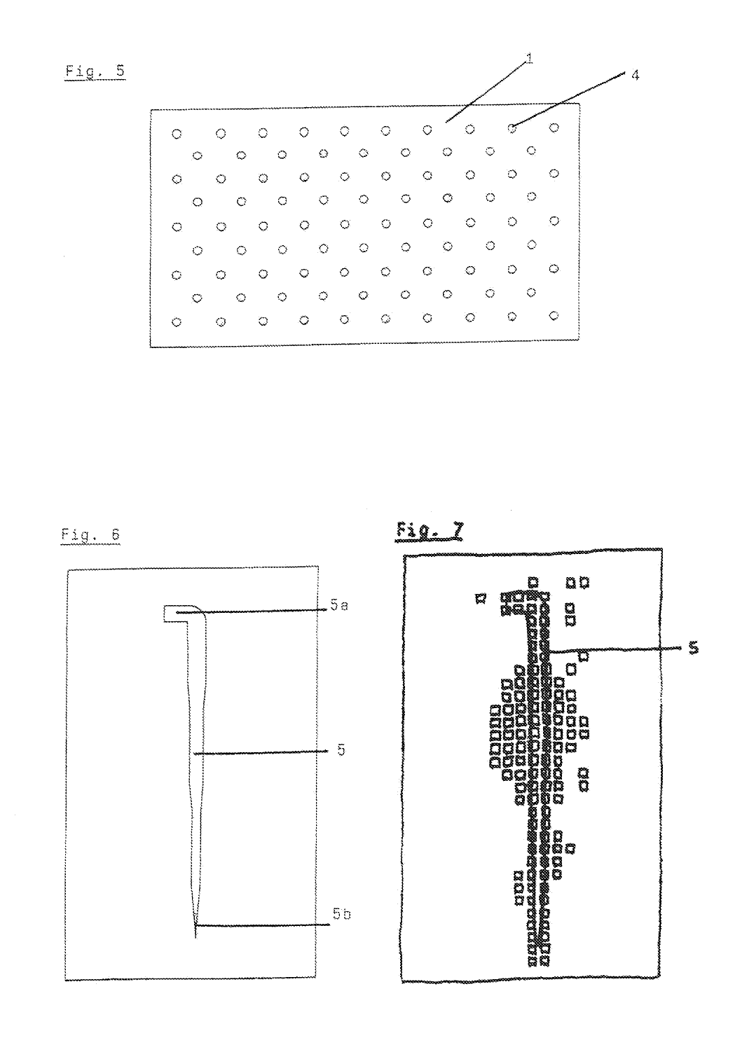

FIG. 6 shows the basic design of a needle 5 with hook 5a and tip 5b. The needle 5 is available to the robot 7 at the removal site 13 and is detected in advance in order for the tool 2 to grasp it. Needle 5 is shown in FIG. 7 as an interim result of a needle detection algorithm, which was generated by the computer 22.

FIGS. 5, 6, 8 and 9 show images that were recorded by camera 6. FIG. 5 pertains to the rear side of the needle board 1 in the empty state. Preparations shall be made for the fitting. The needle bores 4 are relevant. These are detected in order to determine the positions of the needle bores 4 therefrom and to finally determine the position of the robot 7, 8 or of the portal 16.

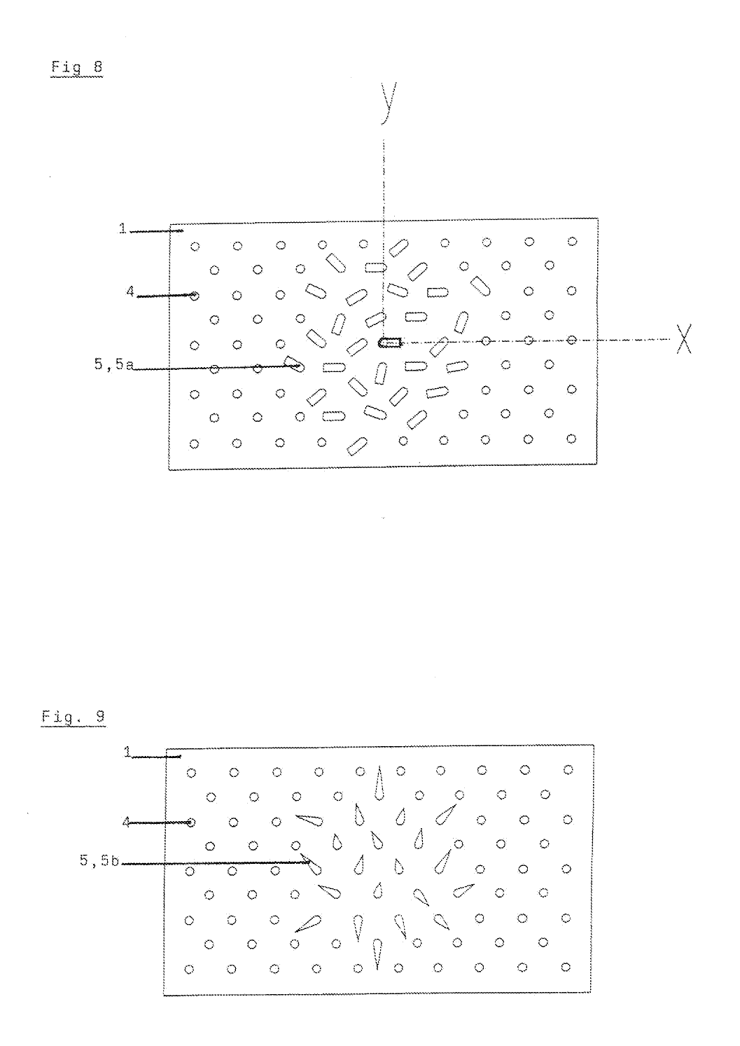

FIG. 8 also shows the rear side of the needle board 1, but it is already fitted with needles 5 here, whose hooks 5a are anchored on the rear side. Preparations shall be made for the removal of the needles 5. The hooks 5b are also to be detected prior to removal, because they may be damaged after the use of the needle board 1 and their positions may have changed as well. Precise detection and fine adjustment of the tool 2 should therefore be performed by means of the best possible positioning of the tool arm 9 of the robot 7, 8 so that it can act from the optimal position. FIG. 8 illustrates the determination of the x and y coordinates, which are necessary for determining the position of the tool, on the basis of a selected needle bore 4, which is located under the hook 5a present there.

FIG. 9 pertains to the front side of the needle board 1, which is already fitted with needles 5, whose tips 5b can be seen here. Preparations shall be made for the operation of selecting damaged needles 5 or for possible subsequent operations, such as repair, straightening, sharpening. Especially the tips 5b of the needles 5 are relevant here. The image data obtained in computer 22 are subjected to a comparison with reference data concerning undamaged needless, and the positions of damaged needles 5 to be selected are determined.

Reference is made to the general part of the specification concerning further features not shown in the figures.

It shall be finally pointed out that the teaching according to the present invention is not limited to the exemplary embodiments explained above. Further possibilities of motion and designs of the tools for carrying out the desired operations, additional operations, such as coating, shaping or machining operations, are rather possible as well. A great variety of couplings of the necessary power transmission means and/or a suitable synchronization software are also possible in view of the synchronization of the robot 8 and of portal 16.

While specific embodiments of the invention have been shown and described in detail to illustrate the application of the principles of the invention, it will be understood that the invention may be embodied otherwise without departing from such principles.

1. A system for the mounting and/or removal as well as for the maintenance of a needle board of a needle machine for nonwoven or needle felt production, the system comprising:
a tool;
a holding device for holding the needle board;
a detection device;
a control and drive device, wherein the tool is positioned in relation to at least one of a needle bore and a needle of the needle board via the control and drive device and the detection device; and
a robot, wherein the tool (2) and the control and drive device are assigned to the robot and the robot comprises a tool arm mounted in an articulated manner and the tool is arranged on the tool arm.

2. A system in accordance with claim 1, wherein the robot is disposed in an area of the needle board at which the operation is carried out.

3. A system in accordance with claim 2, wherein the robot further comprises one of a magnetic field device and rollers whereby the robot is brought into the area of the needle board, at which the operation is carried out, on the rollers (11) or in a floating manner by means of the magnetic field device.

4. A system in accordance with claim 1, wherein the control and drive device further comprises at least one separate computer, which ensures the computing capacity that is needed to position the robot, which coordinates process steps, processes detected data and makes a memory capacity in the gigabyte to terabyte range available.

5. A system in accordance with claim 4, wherein the control and drive device further comprises at least one MPC unit.

6. A system in accordance with claim 1, wherein the tool arm is mounted to move about a plurality of axes.

7. A system in accordance with claim 1, further comprising a removal site for at least one of new needles to be fitted and for removed needles is provided in a range of motion of the tool arm.

8. A system in accordance with claim 1, wherein the detection device comprises a camera for detecting at least one of the needle board the needles and needle bores located at the needle board, the detection device cooperating with the control and drive device.

9. A system in accordance with claim 1, wherein the detection device comprises at least one proximity switch for the detection of at least one of the needle board and tips of the needles.

10. A system in accordance with claim 1, wherein the needle board is mounted rotatably at the holding device.

11. A system in accordance with claim 1, further comprising a portal, via which operations can be carried out at the needle board, is provided in addition to the robot.

12. A system in accordance with claim 11, wherein the portal comprises a tool, which operates in at least three directions of motion.

13. A system in accordance with claim 11, wherein the robot is arranged on the front side of the needle board and the portal is arranged on the rear side of the needle board during the needle removal operation, and said robot and said portal make coordinated operation possible.

14. A system in accordance with claim 1, further comprising a rotatable tool table, wherein the tool is a straightening tool and/or a processing tool that is assigned to the tool arm for repairing a selected needle, and the rotatable tool table has different tools and detection devices arranged thereon.

15. A method for the mounting and/or removal as well as maintenance of a needle board of a needle machine for nonwoven or needle felt production, the method comprising the steps of:
detecting needles or needle bores at the needle board;
positioning a tool in relation to the needle board corresponding to the detected data and performed operations, wherein the operations are carried out via a tool arm of a robot, which is mounted in an articulated manner and on which the tool suitable for the particular desired operation is arranged.

16. A method in accordance with claim 15, wherein depending on the type of the operation, either the front side of the needle board (in case of selection, straightening, repair) or the rear side of the needle board (in case of fitting and removal) is detected prior to an operation, and the positions of the needles or needle bores are determined from this.

17. A method in accordance with claim 16, wherein selected/detected data are sent to a control and drive unit of the robot; and are transformed there into real position data, and the positioning of the robot relative to the needle board is finally performed.

18. A method in accordance with claim 15, wherein to carry out the operation of fitting the needle board with needles via the tool arm or the tool of the robot, a needle is removed from a removal site, wherein a detection device is moved into the area of the removal site before the removal of the needle from the removal site and a needle is detected, after which these detected data are processed electronically such that the position and the quality of the needle are determined and the tool is then actuated to remove the detected needle.

19. A method in accordance with claim 18, wherein a detection of the needle bore is carried out before the insertion of the removed needle into a needle bore, the detected data are sent to the drive and control unit, and fine adjustment of the position of the tool carrying the removed needle is carried out.

20. A method in accordance with claim 15, wherein the end of the needle that is seated in the needle bore is detected on the rear side of the needle board before the operation of removing a needle, after which the detected data are processed electronically such that the position and the quality of the end of the needle are determined and the tool is then actuated to apply pressure to the detected end of the needle.

21. A method in accordance with claim 15, wherein prior to the operation of selecting a needle, this needle is detected on the front side of the needle board and that the detected data are subjected in the control and drive unit to a comparison with reference data concerning an undamaged needle and the position of the damaged needle that is possibly to be selected is determined.

22. A method in accordance with claim 21, wherein positioning of the robot in relation to the corresponding area of the needle board is carried out after determining the position of needles that deviate from the reference data.

23. A method in accordance with claim 21, wherein it is determined in the control and drive unit whether the selected needle is to removed, repaired and especially straightened.

24. A method in accordance with claim 23, wherein the repair of the selected needle is carried out corresponding to the reference data stored in the control and drive device.

25. A needle for a needle board of a needle machine for nonwoven or needle felt production, the needle comprising:
a tip and with an end located opposite the tip, wherein the end of the needle located opposite the tip comprises a flat, round or elliptical head, which is slightly larger than a cross section of the needle.
